(19) United States
(12) Patent Application Publication
(10) Pub. No.: US 2023/0122947 A1
(43) Pub. Date: Apr. 20, 2023

(54) SYSTEMS, DEVICES, AND METHODS FOR STRUCTURING, DEPLOYING, AND MANAGING COMPLEX ENTERPRISE NETWORKS

(71) Applicant: Pericles P DeAvila, Hayward, CA (US)

(72) Inventor: Pericles P DeAvila, Hayward, CA (US)

(21) Appl. No.: 17/966,875

(22) Filed: Oct. 16, 2022

Related U.S. Application Data
(60) Provisional application No. 63/257,550, filed on Oct. 19, 2021.
(60) Provisional application No. 63/257,553, filed on Oct. 19, 2021.

(51) Int. Cl. G06Q 10/10; G06Q 10/0631

(52) U.S. Cl. CPC G06Q 10/103; G06Q 10/06313

(57) ABSTRACT

Systems, devices, and methods are described for providing, among other things, a digital collaboration platform configured to structure, deploy, monitor, and manage complex enterprise networks. In an embodiment, the digital collaboration platform enables centralized interconnected collaborative tools that are generated responsive to one or more inputs indicative of a project type, a project category, a project deliverable, a project scope, a project location, a project funding source, and the like.

### RELATED APPLICATIONS

This application claims the benefit of priority under 35 USC § 119(e) of U.S. Provisional Pat. Application No. 63/257,550 (filed Oct. 19, 2021) and U.S. Provisional Pat. Application No. 63/257,553 (filed Oct. 19, 2021), the contents of which are incorporated herein by reference in their entirety.

### SUMMARY

In an aspect, the present disclosures is directed to enterprise management system configured to structure, deploy, monitor, and manage complex enterprise networks.

In an embodiment the system includes circuitry configured to generate a project management application set responsive to one or more inputs indicative of a project type, a project category, a project deliverable, a project deliverable and project geographical scope, or a project deliverable and project funding source.

In an embodiment the system includes circuitry configured to generate a project management application set responsive to receiving project information(e. g., a project type (e.g., construction project, engineering project, sustainability project, etc.), a project category, a project deliverable, a project geographical scope, a project deliverable, funding source, and the like.)

In an embodiment the system includes circuitry configured to generate one or more instance of user selectable project management architectures on a graphical user interface. In an embodiment the system includes circuitry configured to generate one or more instance of user selectable project specific digital tools suites based on project information analytics on a graphical user interface. In an embodiment the system includes circuitry configured to generate one or more instance of an initial set of collaboration modules needed to carry out project deliverables based on project criteria. In an embodiment the system includes circuitry configured to generate one or more instance of predictive cost analytics, predictive resource allocation.

In an embodiment the system includes circuitry configured to generate one or more instance of predictive project deliverables, timelines, and request for proposals. In an embodiment the system includes circuitry configured to generate one or more instance of predictive project dashboards. In an embodiment the system includes circuitry configured to broadcast opportunities, request for proposals, and product bid request to member network, ecosystem user, and vetted ecosystem partners. In an embodiment the system includes circuitry configured to initiate, monitor, and auto manage vendors, products, and resources vetting. In an embodiment the system includes circuitry configured to generate an initial set of product manufacturers and supply chain partners.

### BRIEF DESCRIPTION OF THE FIGURES

FIG. 1 is a schematic diagram of an ecosystem for structuring, deploying, and managing complex enterprise networks according one embodiment.

FIG. 2 is a schematic diagram of an ecosystem for structuring, deploying, and managing complex enterprise networks according one embodiment.

FIG. 3 is a schematic diagram of a Product Management Uni according one embodiment.

FIG. 4 is a schematic diagram of a Member Social Media Unit according one embodiment.

FIG. 5 is a schematic diagram of a Digital Wallet Unit according one embodiment.

FIG. 6 is a schematic diagram of an Advertisement Unit according one embodiment.

FIG. 7 is a schematic diagram of a Data Analytics Unit according one embodiment.

FIG. 8 is a schematic diagram of a Messaging Application Unit

FIG. 9 is a schematic diagram of a Deal Room Unit according one embodiment.

FIG. 10 is a schematic diagram of a Marketplace Unit according one embodiment.

FIG. 11 is a schematic diagram of a Product Management Unit according one embodiment.

FIG. 12 is a schematic diagram of a Fraud Detection Unit according one embodiment.

FIG. 13 is a schematic diagram of a Credentialing Unit according one embodiment.

FIG. 14 shows a flow diagram of a method according to one embodiment.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented here.

### DETAILED DESCRIPTION

Global complex projects often involve specialized teams, located in various geographical locations, each under a different management structure, a different political structure, and each with different deliverables, goals, and objectives making project management difficult and centralized cost management impossible. Accordingly, in an embodiment, the disclosed technologies and methodologies are directed to a digital platform and a technology stack configured to structure, deploy, monitor, and manage complex enterprise networks.

In an embodiment, the disclosed technologies and methodologies are directed to, among other things, a digital collaboration platform that enables centralized interconnected collaborative tools. In an embodiment, the disclosed technologies and methodologies include computational circuitry configured to create project management architectures and project specific digital tools suites based on project information analytics. In an embodiment, the disclosed technologies and methodologies include computational circuitry configured to generate an initial set of collaboration modules needed to carry out project deliverables based on project criteria

In an embodiment, the disclosed technologies and methodologies include computational circuitry configured to generate predictive cost analytics. In an embodiment, the disclosed technologies and methodologies include computational circuitry configured to generate predictive resource allocation. In an embodiment, the disclosed technologies and methodologies include computational circuitry configured to generate predictive project deliverables, timelines, and request for proposals. In an embodiment, the disclosed technologies and methodologies include computational circuitry configured to generate predictive project dashboards.

In an embodiment, the disclosed technologies and methodologies include computational circuitry configured to broadcast opportunities, request for proposals, product bid request, and the like to member network, ecosystem user, and vetted ecosystem partners. In an embodiment, the disclosed technologies and methodologies include computational circuitry configured to initiate, monitor, and auto manage vendors, products, and resources vetting. In an embodiment, the disclosed technologies and methodologies include computational circuitry configured to generate an initial set of product manufacturers and supply chain partners.

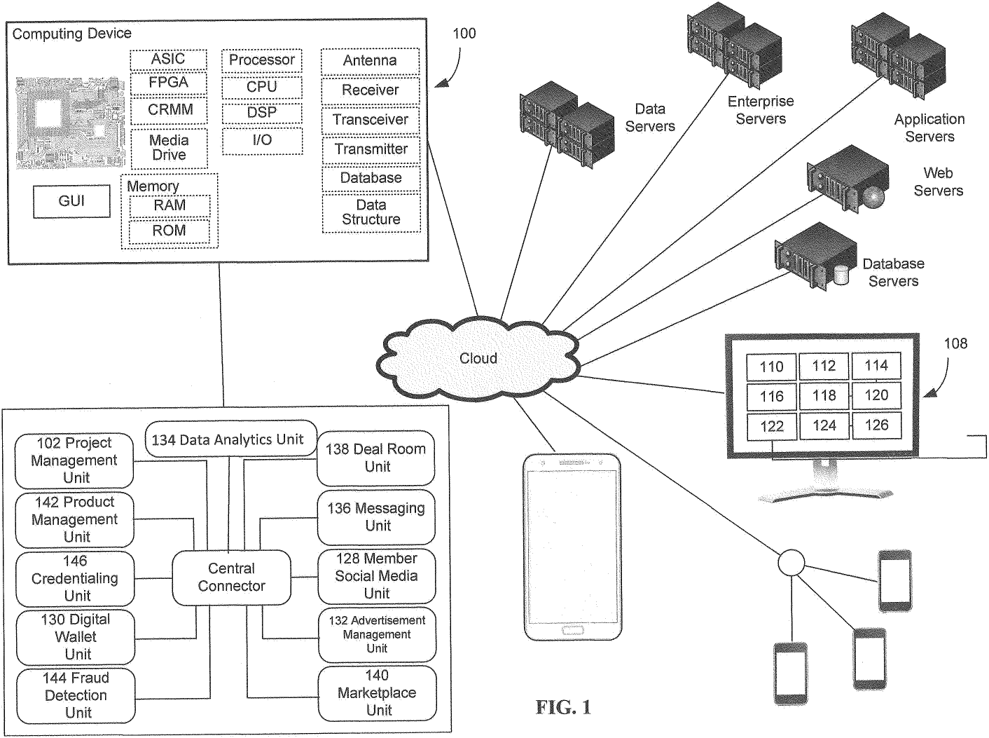

FIGS. 1 & 2 show an enterprise system 100 in which one or more of the disclosed methodologies or technologies can be implemented such as, for example, an enterprise management system configured to structure, deploy, monitor, manage complex enterprise networks, and the like.

### Project Management Unit

In an embodiment, the enterprise system 100 includes a Project Management Unit 102. In an embodiment, the Project Management Unit 102 includes circuitry configured to generate a project management application set responsive to one or more inputs indicative of a project type, a project category, a project deliverable, and the like.

In an embodiment, the Project Management Unit 102 includes circuitry configured to generate a project management application set responsive to one or more inputs indicative of a project deliverable and project geographical scope. In an embodiment, the Project Management Unit 102 includes circuitry configured to generate a project management application set responsive to one or more inputs indicative of a project deliverable and project funding source.

In an embodiment, the Project Management Unit 102 includes circuitry configured to generate a project digital app set based on project information (e. g., a project type (e.g., construction project, engineering project, sustainability project, etc.), a project category, a project deliverable, a project geographical scope, a project deliverable, funding source, and the like.

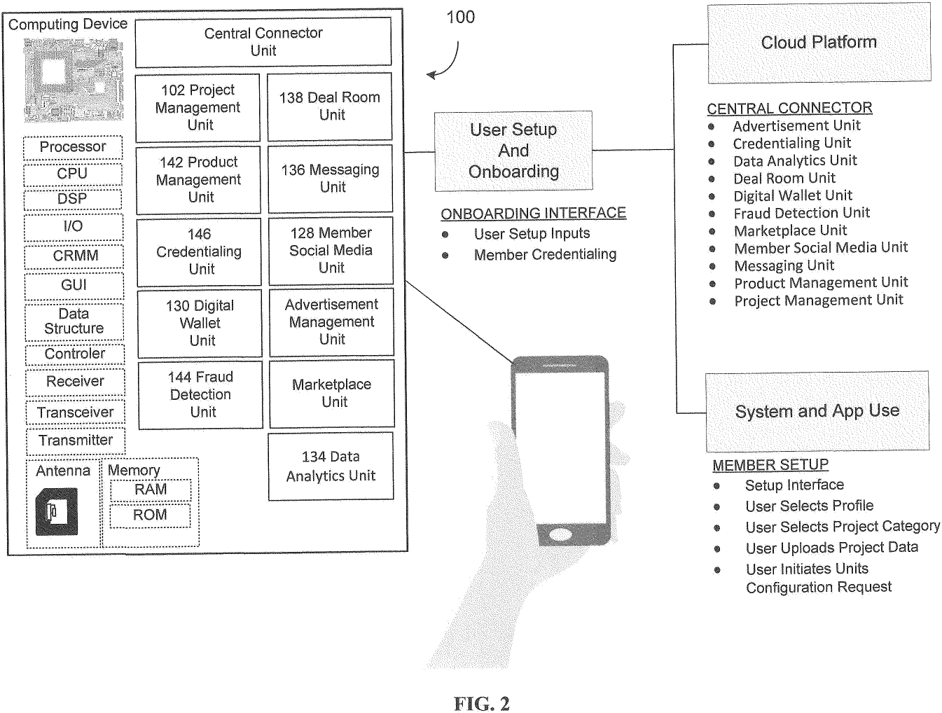

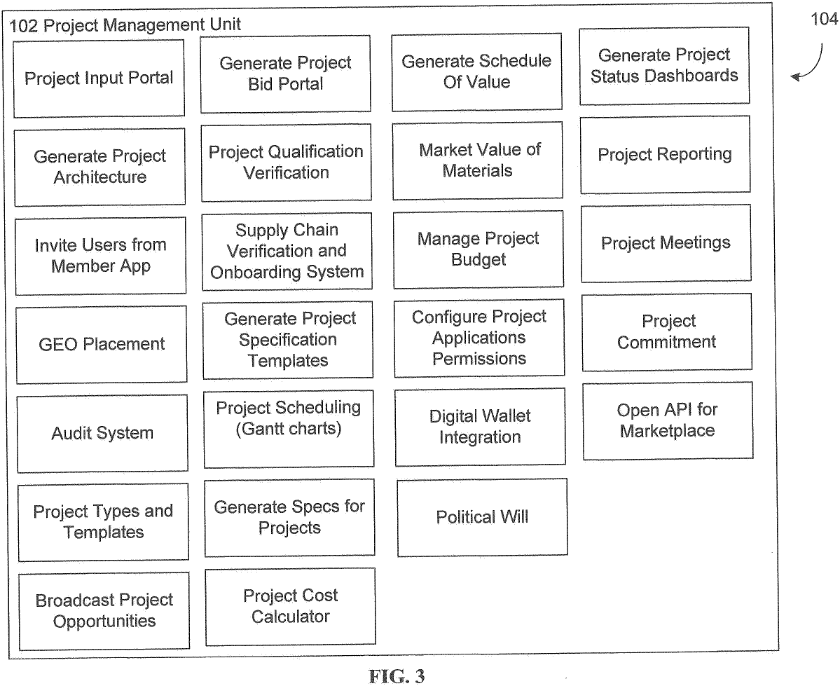

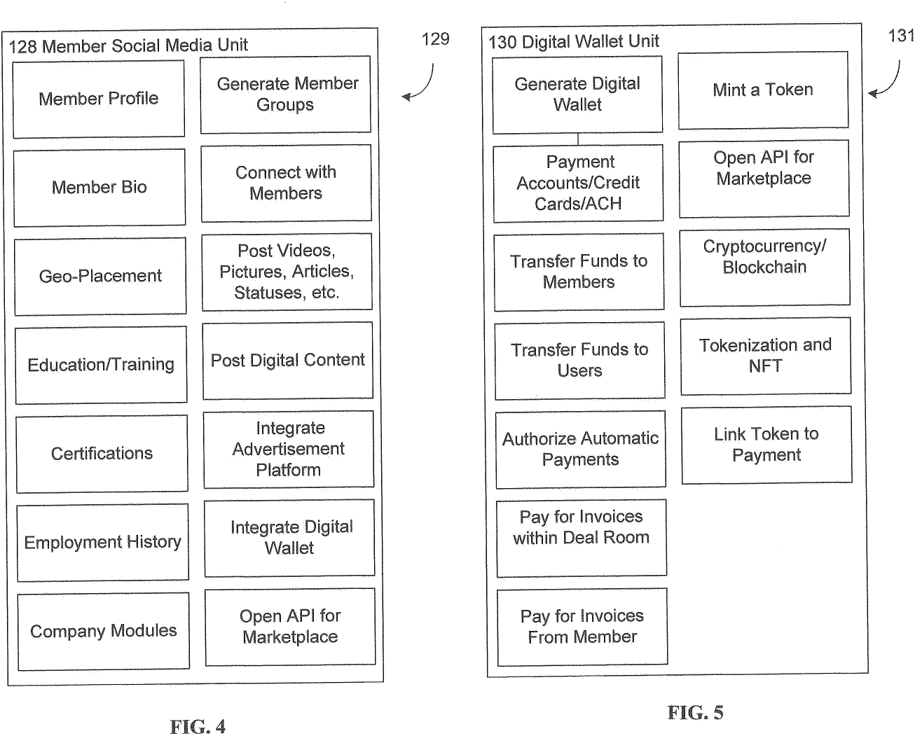

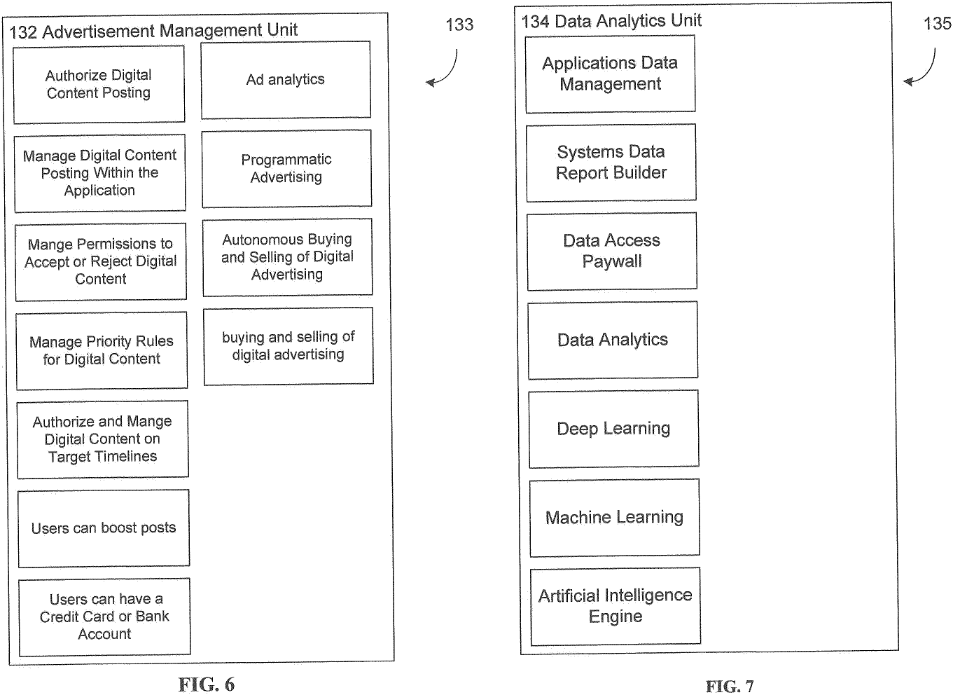

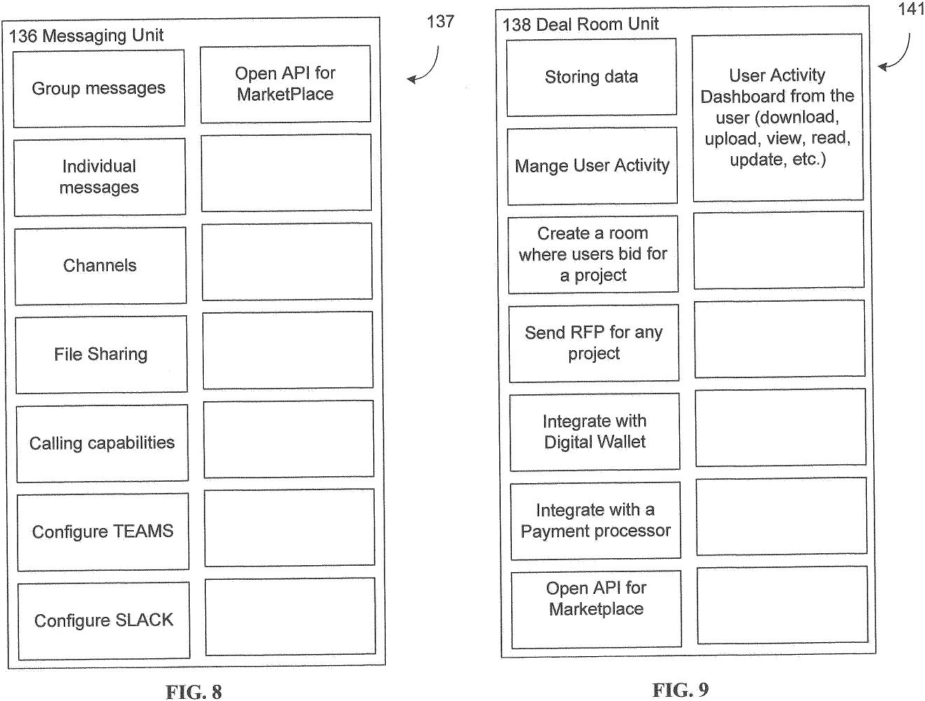

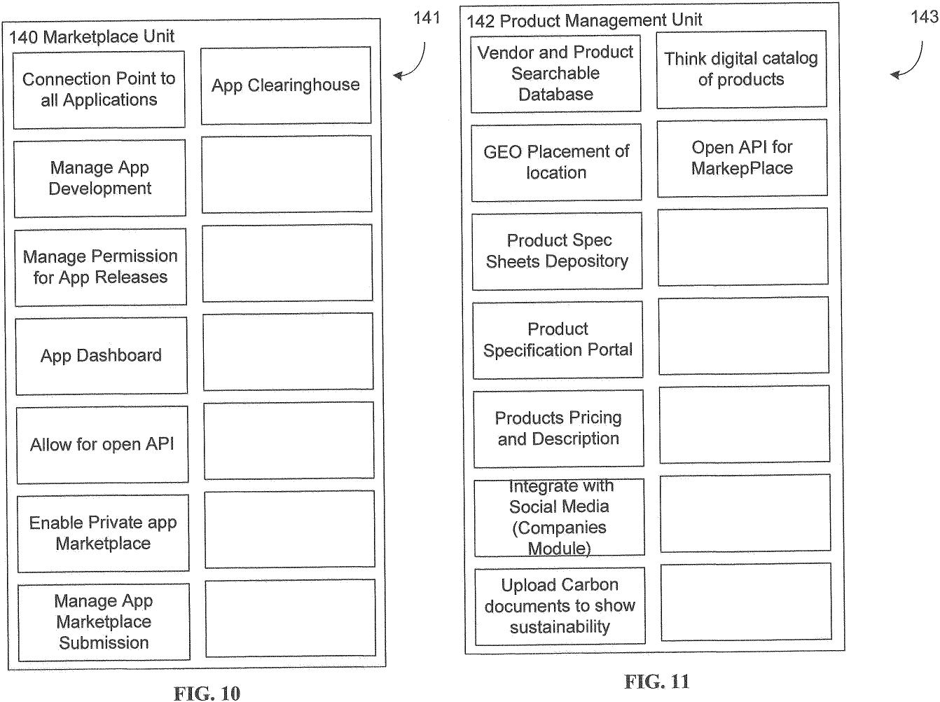

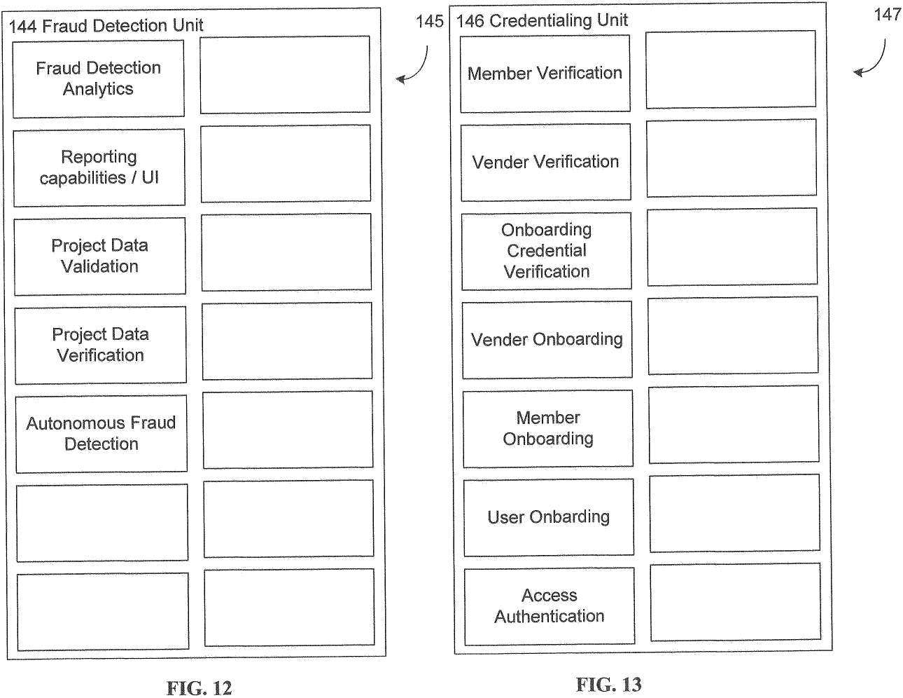

Referring to FIGS. 1, 2, & 3, in an embodiment, the Project Management Unit 102 includes circuitry configured to generate one or more instance of user selectable project management architectures on a graphical user interface. In an embodiment, the Project Management Unit 102 includes circuitry configured to generate one or more instance of user-selectable, project-specific digital tools suites 104 based on project information analytics on a graphical user interface.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, circuitry includes one or more ASICs having a plurality of predefined logic components. In an embodiment, circuitry includes one or more FPGA having a plurality of programmable logic components.

In an embodiment, circuitry includes one or more electrical components operably coupled (e.g., communicatively, electromagnetically, magnetically, ultrasonically, optically inductively, electrically, capacitively coupled, and the like) to each other. In an embodiment, circuitry includes one or more remotely located components. In an embodiment, remotely located components are operably coupled via wireless communication. In an embodiment, remotely located components are operably coupled via one or more receivers, transceivers, or transmitters, antennas, or the like.

In an embodiment, circuitry includes one or more network elements. Non-limiting examples of network elements include Local Area Networks (LANs), network gateway systems, network usage servers, Wide Area Networks (WANs), wireless base stations, wireless relays, and the like. In an embodiment, circuitry includes computer and communication platforms that include data Input/Output (I/O) transceivers, digital processing circuitry, data storage memories, various software components, and the like.

In an embodiment, circuitry includes one or more memory devices that, for example, store instructions or data for example, in an embodiment, the enterprise system 100 includes one or more memory devices storing user-specific sustainability information, user-specific carbon footprint information, enterprise-wide sustainability information, or enterprise-wide carbon footprint information with a remote client device and remote server. Non-limiting examples of one or more memory devices include volatile memory (e.g., Random Access Memory (RAM), Dynamic Random-Access Memory (DRAM), or the like); non-volatile memory (e.g., Read-Only Memory (RUM), Electrically Erasable Programmable Read-Only Memory (EEPROM), Flash memory, or the like); persistent memory; or the like. The one or more memory device can be coupled to, for example, one or more computing devices by one or more instructions, data, or power buses.

In an embodiment, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, circuitry includes one or more user input/output components that are operably coupled to at least one computing device to control (electrical, electromechanical, software-implemented, firmware-implemented, or other control, or combinations thereof) at least one parameter associated with, for example, generating a user interface presenting a rating menu and receive one or more inputs indicative of a rating associated with the event based on the rating menu.

In an embodiment, circuitry includes a computer-readable media drive or memory slot that is configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., receiver, transceiver, or transmitter, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

In an embodiment, circuitry includes computing circuitry, memory circuitry, electrical circuitry, electro-mechanical circuity, control circuitry, transceiver circuitry, transmitter circuitry, receiver circuitry, and the like. For example, in an embodiment, the Project Management Unit 102 comprises one or more of computing device circuitry, memory circuitry, and at least one of transceiver circuitry, transmitter circuitry, and receiver circuitry.

In an embodiment, the Project Management Unit 102 includes circuitry configured to generate one or more instance of an initial set of collaboration modules needed to carry out project deliverables based on project criteria. In an embodiment, the Project Management Unit 102 includes circuitry configured to generate one or more instance of predictive cost analytics, predictive resource allocation. In an embodiment, the Project Management Unit 102 includes circuitry configured to generate project dashboards 106 including one or more instance of predictive project deliverables 108, predictive resource allocation 110, project timelines 112, request for proposals status 114, project architectures 116, predictive analytics 118, and the like.

In an embodiment, the Project Management Unit 102 includes circuitry configured to generate project dashboards 106 including one or more instance of predictive cost analytics 120, project work schedules 122, invoice tracking and payment 124, Building Spec Templates status 126, and the like.

In an embodiment, the Project Management Unit 102 includes circuitry configured to broadcast opportunities, request for proposals, and product bid request to member network, ecosystem user, and vetted ecosystem partners. In an embodiment, the Project Management Unit 102 includes circuitry configured to initiate, monitor, and auto-manage vendors, products, and resources vetting. In an embodiment, the Project Management Unit 102 includes circuitry configured to generate an initial set of product manufacturers and supply chain partners.

### Social Media Unit

Referring to FIGS. 1, 2, & 4, in an embodiment, the enterprise system 100 includes a Member Social Media Unit 128 including circuitry configured to generate a member social media application set.

In an embodiment, the Member Social Media Unit 128 includes circuitry configured to generate one or more instance of user-selectable, project-specific, member social media application set 129 based on project information, on a graphical user interface.

In an embodiment, the Member Social Media Unit includes circuitry configured to generate a member social media set responsive to one or more inputs indicative of a project type, a project category, a project deliverable, a project deliverable and project geographical scope, or a project deliverable and project funding source.

### Digital Wallet Unit

Referring to FIGS. 1, 2, & 5, in an embodiment, the enterprise system 100 includes a Digital Wallet Unit 130 including circuitry configured to generate a digital wallet application set.

In an embodiment, the Digital Wallet Unit 130 includes circuitry configured to generate one or more instance of user-selectable, project-specific, digital wallet application set 131 based on project information, on a graphical user interface.

In an embodiment, the Digital Wallet Unit includes circuitry configured to generate a digital wallet application set responsive to one or more inputs indicative of a project type, a project category, a project deliverable, a project deliverable and project geographical scope, or a project deliverable and project funding source.

In an embodiment, the Digital Wallet Unit includes circuitry configured to facilitating payment to a digital wallet responsive to receiving one or more inputs indicative of transaction for to buy or sell member products or member services.

In an embodiment, the Digital Wallet Unit includes circuitry configured to connect with a payment account, a credit card service, and Automated Clearing House (ACH) account, a cryptocurrency wallet, or combinations thereof.

In an embodiment, the Digital Wallet Unit includes circuitry configured to enable users to send other users funds.

In an embodiment, the Digital Wallet Unit includes circuitry configured to enable users to pay for invoices from other members within a digital deal room.

In an embodiment, the Digital Wallet Unit includes circuitry configured to enable automatic payments for authorized invoices.

In an embodiment, the Digital Wallet Unit includes circuitry configured to Cryptocurrency exchange.

In an embodiment, the Digital Wallet Unit includes circuitry configured to enable Token minting.

In an embodiment, the Digital Wallet Unit includes circuitry configured to enable Non Fungible Tokens (NFTs).

### Advertisement Unit

Referring to FIGS. 1, 2, & 6, in an embodiment, the enterprise system 100 includes an Advertisement Unit 132 including circuitry configured to generate an advertisement application set.

In an embodiment, the Advertisement Unit 132 includes circuitry configured to generate one or more instance of user-selectable, project-specific, advertisement application set 133 based on project information, on a graphical user interface.

In an embodiment, the Advertisement Unit includes circuitry configured to generate an advertisement application set responsive to one or more inputs indicative of a project type, a project category, a project deliverable, a project deliverable and project geographical scope, or a project deliverable and project funding source.

In an embodiment, the Advertisement Unit includes circuitry configured to enable users to post ads to be posted on different pages of the application

In an embodiment, the Advertisement Unit includes circuitry configured to Manage

In an embodiment, the Advertisement Unit includes circuitry configured to enable Programmatic Advertising.

In an embodiment, the Advertisement Unit includes circuitry configured to enable Autonomous Buying and Selling of Digital Advertising.

In an embodiment, the Advertisement Unit includes circuitry configured to enable Authorize Digital Content Posting.

In an embodiment, the Advertisement Unit includes circuitry configured to enable Manage Digital Content Posting Within the Application.

In an embodiment, the Advertisement Unit includes circuitry configured to Mange Permissions to Accept or Reject Digital Content.

In an embodiment, the Advertisement Unit includes circuitry configured to Manage Priority Rules for Digital Content.

In an embodiment, the Advertisement Unit includes circuitry configured to enable Authorization protocols and Mange Digital Content on Target Timelines.

In an embodiment, the Advertisement Unit includes circuitry configured to enable

### Data Analytics Unit

Referring to FIGS. 1, 2, & 7, in an embodiment, the enterprise system 100 includes a Data Analytics Unit 134 including circuitry configured to generate a member data analytics application set responsive.

In an embodiment, the Data Analytics Unit 134 includes circuitry configured to generate one or more instance of user-selectable, project-specific, member data analytics application set 135 based on project information, on a graphical user interface.

In an embodiment, the Data Analytics Unit includes circuitry configured to generate a member data analytics set responsive to one or more inputs indicative of a project type, a project category, a project deliverable, a project deliverable and project geographical scope, or a project deliverable and project funding source.

In an embodiment, the Data Analytics Unit includes circuitry configured to access and exchange data within enterprise system applications.

In an embodiment, the Data Analytics Unit includes circuitry configured to generate a Report builder to analyze project data and built reports.

In an embodiment, the Data Analytics Unit includes circuitry configured to enable a Paywall to allow users to buy access to the data.

### Messaging Unit

Referring to FIGS. 1, 2, & 8, in an embodiment, the enterprise system 100 includes a Messaging Unit 136 including circuitry configured to generate a messaging application set.

In an embodiment, the Messaging Unit 136 includes circuitry configured to generate one or more instance of user-selectable, project-specific, messaging application set 137 based on project information, on a graphical user interface.

In an embodiment, the Messaging Unit includes circuitry configured to generate a messaging application set responsive to one or more inputs indicative of a project type, a project category, a project deliverable, a project deliverable and project geographical scope, or a project deliverable and project funding source.

### Deal Room Unit

Referring to FIGS. 1, 2, & 9, in an embodiment, the enterprise system 100 includes a Deal Room Unit 138 including circuitry configured to generate a Deal Room application set.

In an embodiment, the Deal Room Unit 138 includes circuitry configured to generate one or more instance of user-selectable, project-specific, Deal Room application set 139 based on project information, on a graphical user interface.

In an embodiment, the Deal Room Unit includes circuitry configured to generate a Deal Room application set responsive to one or more inputs indicative a project type, a project category, a project deliverable, a project deliverable and project geographical scope, or a project deliverable and project funding source.

In an embodiment, the Deal Room Unit includes circuitry configured to generate a Deal Room application set responsive to one or more inputs indicative a project type, a project category, a project deliverable, a project deliverable and project geographical scope, or a project deliverable and project funding source.

### Marketplace Unit

Referring to FIGS. 1, 2, & 10, in an embodiment, the enterprise system 100 includes a Marketplace Unit 140 including circuitry configured to generate a marketplace application set.

In an embodiment, the Marketplace Unit 140 includes circuitry configured to generate one or more instance of user-selectable, project-specific, marketplace application set 141 based on project information, on a graphical user interface.

In an embodiment, the Marketplace Unit includes circuitry configured to generate a marketplace application set responsive to one or more inputs indicative of a project type, a project category, a project deliverable, a project deliverable and project geographical scope, or a project deliverable and project funding source.

In an embodiment, the Marketplace Unit includes circuitry configured to Connection point to all applications

In an embodiment, the Marketplace Unit includes circuitry configured to allow apps to be developed and submitted to the marketplace.

In an embodiment, the Marketplace Unit includes circuitry configured to required approval process to release apps onto the application.

In an embodiment, the Marketplace Unit includes circuitry configured to enable searchable front end to see apps that are connected.

In an embodiment, the Marketplace Unit includes circuitry configured to enable open API and ability to connect to any app without a public app in the marketplace.

### Product Management Unit

Referring to FIGS. 1, 2, & 11, in an embodiment, the enterprise system 100 includes a Product Management Unit 142 including circuitry configured to generate a product management application set.

In an embodiment, the Product Management Unit 142 includes circuitry configured to generate one or more instance of user-selectable, project-specific, product management application set 143 based on project information, on a graphical user interface.

In an embodiment, the Product Management Unit includes circuitry configured to generate a Product Management application set responsive to one or more inputs indicative of a project type, a project category, a project deliverable, a project deliverable and project geographical scope, or a project deliverable and project funding source.

In an embodiment, the Product Management Unit includes circuitry configured to broadcast vendor and product opportunities to member network.

In an embodiment, the Product Management Unit includes circuitry configured to broadcast vendor and product opportunities to ecosystem users.

In an embodiment, the Product Management Unit includes circuitry configured to broadcast vendor and product opportunities to vetted ecosystem users.

In an embodiment, the Product Management Unit includes circuitry configured to broadcast vendor and product opportunities.

In an embodiment, the Product Management Unit includes circuitry configured to broadcast vendor and product opportunities to member network, ecosystem user, and vetted ecosystem users.

In an embodiment, the Product Management Unit includes circuitry configured to broadcast request for proposals to member network, ecosystem user, and vetted ecosystem users.

In an embodiment, the Product Management Unit includes circuitry configured to broadcast product bid request to member network, ecosystem user, and vetted ecosystem users.

In an embodiment, the Product Management Unit includes circuitry configured to initiate, monitor, and auto manage vendors, products, and resources vetting.

In an embodiment, the Product Management Unit includes circuitry configured to generate an initial set of product manufacturers and supply chain partners.

### Fraud Detection Unit

Referring to FIGS. 1, 2, & 12, in an embodiment, the enterprise system 100 includes a Fraud Detection Unit 144 including circuitry configured to generate a fraud detection application set.

In an embodiment, the Fraud Detection Unit 144 includes circuitry configured to generate one or more instance of user-selectable, project-specific, fraud detection application set 145 based on project information, on a graphical user interface.

In an embodiment, the Fraud Detection Unit includes circuitry configured to generate a fraud detection application set responsive to one or more inputs indicative of a project type, a project category, a project deliverable, a project deliverable and project geographical scope, or a project deliverable and project funding source.

In an embodiment, the Fraud Detection Unit includes circuitry configured to connect to all Applications to detect fraudulent activity.

In an embodiment, the Fraud Detection Unit includes circuitry configured to enable Reporting capabilities / Ul

In an embodiment, the Fraud Detection Unit includes circuitry configured to Validate and Verify project data.

### Credentialing Unit

Referring to FIGS. 1, 2, & 13, in an embodiment, the enterprise system 100 includes a Credentialing Unit 146 including circuitry configured to generate a credentialing application set.

In an embodiment, the Credentialing Unit 146 includes circuitry configured to generate one or more instance of user-selectable, project-specific, credentialing application set 147 based on project information, on a graphical user interface.

In an embodiment, the Credentialing Unit includes circuitry configured to generate a credentialing application set responsive to one or more inputs indicative of a project type, a project category, a project deliverable, a project deliverable and project geographical scope, or a project deliverable and project funding source.

In an embodiment, a method includes generating a project management application set; generating a marketplace application set; generating a deal Room application set; generating a credentialing application set; generating an Advertisement application set; generating a messaging application set; generating a fraud detection application set; generating a digital wallet application set; generating a member social media application set; generating a member data analytics application set; and generating a product management application set.

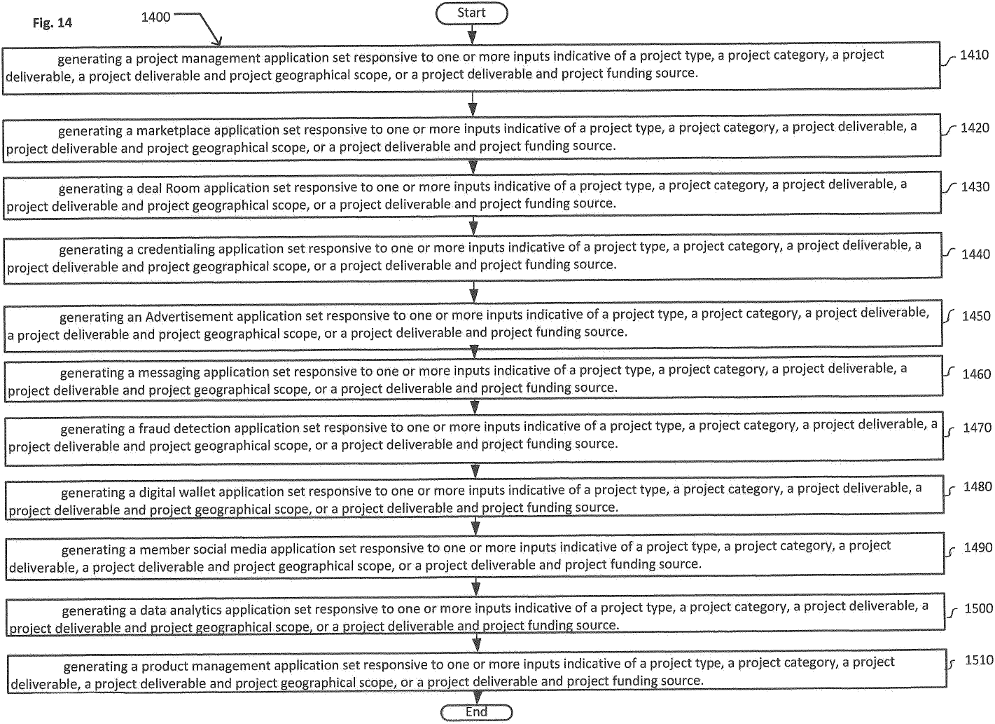

FIG. 14 shows a method 1400 for implementing one or more technologies and methodologies.

At 1410 the method 1400 includes generating a project management application set responsive to one or more inputs indicative of a project type, a project category, a project deliverable, a project deliverable and project geographical scope, or a project deliverable and project funding source. At 1420 the method 1400 includes generating a marketplace application set responsive to one or more inputs indicative of a project type, a project category, a project deliverable, a project deliverable and project geographical scope, or a project deliverable and project funding source. At 1430 the method 1400 includes generating a deal Room application set responsive to one or more inputs indicative of a project type, a project category, a project deliverable, a project deliverable and project geographical scope, or a project deliverable and project funding source.

At 1440 the method 1400 includes generating a credentialing application set responsive to one or more inputs indicative of a project type, a project category, a project deliverable, a project deliverable and project geographical scope, or a project deliverable and project funding source. At 1450 the method 1400 includes generating an advertisement application set responsive to one or more inputs indicative of a project type, a project category, a project deliverable, a project deliverable and project geographical scope, or a project deliverable and project funding source. At 1460 the method 1400 includes generating a messaging application set responsive to one or more inputs indicative of a project type, a project category, a project deliverable, a project deliverable and project geographical scope, or a project deliverable and project funding source.

At 1470 the method 1400 includes generating a fraud detection application set responsive to one or more inputs indicative of a project type, a project category, a project deliverable, a project deliverable and project geographical scope, or a project deliverable and project funding source. At 1480 the method 1400 includes generating a digital wallet application set responsive to one or more inputs indicative of a project type, a project category, a project deliverable, a project deliverable and project geographical scope, or a project deliverable and project funding source. At 1490 the method 1400 includes generating a member social media application set responsive to one or more inputs indicative of a project type, a project category, a project deliverable, a project deliverable and project geographical scope, or a project deliverable and project funding source.

At 1500 the method 1400 includes generating a data analytics application set responsive to one or more inputs indicative of a project type, a project category, a project deliverable, a project deliverable and project geographical scope, or a project deliverable and project funding source. At 1510 the method 1400 includes generating a product management application set responsive to one or more inputs indicative of a project type, a project category, a project deliverable, a project deliverable and project geographical scope, or a project deliverable and project funding source.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include, but are not limited to, physically mateable, physically interacting components, wirelessly interactable, wirelessly interacting components, logically interacting, logically intractable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can encompass active-state components, or inactive-state components, or standby-state components, unless context requires otherwise.

The foregoing detailed description has set forth various embodiments of the devices or processes via the use of block diagrams, flowcharts, or examples. As far as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific integrated Circuits (ASICs), Field Programmable Gate Arrays (PDAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the type of signal-bearing medium used to carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link a wireless communication link (e.g., transmitter, receiver, transmission logic, reception logic, etc.), etc.).

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are intended as “open” terms (e.g., the term “including” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include but not be limited to systems that have A alone, B alone, C alone, A and S together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. An enterprise system, comprising:
a Project Management Unit including circuitry configured to generate a project management application set responsive to one or more inputs indicative of a project type, a project category, a project deliverable, a project deliverable and project geographical scope, or a project deliverable and project funding source.

2. The enterprise system of claim 1, wherein the Project Management Unit includes circuitry configured to generate one or more instance of user selectable project management architectures on a graphical user interface.

3. (canceled)

4. (canceled)

5. (canceled)

6. (canceled)

7. (canceled)

8. (canceled)

9. (canceled)

10. (canceled)

11. The enterprise system of claim 1, further comprising:
a Marketplace Unit including circuitry configured to generate a marketplace application set.

12. The enterprise system of claim 11, wherein the Marketplace Unit includes circuitry configured to generate a marketplace application set responsive to one or more inputs indicative of a project type, a project category, a project deliverable, a project deliverable and project geographical scope, or a project deliverable and project funding source.

13. The enterprise system of claim 1, further comprising:
a Deal Room Unit including circuitry configured to generate a Deal Room application set.

14. The enterprise system of claim 13, wherein the Deal Room Unit includes circuitry configured to generate a Deal Room application set responsive to one or more inputs indicative a project type, a project category, a project deliverable, a project deliverable and project geographical scope, or a project deliverable and project funding source.

15. (canceled)

16. The enterprise system of claim 1, further comprising:
a Credentialing Unit including circuitry configured to generate a credentialing application set.

17. The enterprise system of claim 16, wherein the Credentialing Unit includes circuitry configured to generate the credentialing application set responsive to one or more inputs indicative of a project type, a project category, a project deliverable, a project deliverable and project geographical scope, or a project deliverable and project funding source.

18. The enterprise system of claim 1, further comprising:
an Advertisement Unit including circuitry configured to generate an advertisement application set.

19. The enterprise system of claim 18, wherein the Advertisement Unit includes circuitry configured to generate an advertisement application set responsive to one or more inputs indicative of a project type, a project category, a project deliverable, a project deliverable and project geographical scope, or a project deliverable and project funding source.

20. (canceled)

21. (canceled)

22. (canceled)

23. (canceled)

24. (canceled)

25. (canceled)

26. (canceled)

27. (canceled)

28. (canceled)

29. The enterprise system of claim 1, further comprising:
a Messaging Unit including circuitry configured to generate a messaging application set.

30. The enterprise system of claim 29, wherein the Messaging Unit includes circuitry configured to generate a messaging application set responsive to one or more inputs indicative of a project type, a project category, a project deliverable, a project deliverable and project geographical scope, or a project deliverable and project funding source.

31. The enterprise system of claim 1, further comprising:
a Fraud Detection Unit including circuitry configured to generate a fraud detection application set.

32. (canceled)

33. (canceled)

34. (canceled)

35. The enterprise system of claim 1, further comprising:
a Digital Wallet Unit including circuitry configured to generate a digital wallet application set.

36. (canceled)

37. (canceled)

38. (canceled)

39. (canceled)

40. (canceled)

41. (canceled)

42. (canceled)

43. (canceled)

44. (canceled)

45. The enterprise system of claim 1, further comprising:
a Member Social Media Unit including circuitry configured to generate a member social media application set.

46. (canceled)

47. The enterprise system of claim 1, further comprising:
a Data Analytics Unit including circuitry configured to generate a member data analytics application set responsive.

48. (canceled)

49. (canceled)

50. (canceled)

51. (canceled)

52. The enterprise system of claim 1, further comprising:
a Product Management Unit including circuitry configured to generate a Product Management application set.

53. The enterprise system of claim 52, wherein the Product Management Unit includes circuitry configured to generate a Product Management application set responsive to one or more inputs indicative of a project type, a project category, a project deliverable, a project deliverable and project geographical scope, or a project deliverable and project funding source.

54. (canceled)

55. (canceled)

56. (canceled)

57. (canceled)

58. (canceled)

59. (canceled)

60. (canceled)

61. (canceled)

62. (canceled)

63. A method, comprising:
generating a project management application set;
generating a marketplace application set;
generating a deal Room application set;
generating a credentialing application set;
generating an Advertisement application set;
generating a messaging application set;
generating a fraud detection application set;
generating a digital wallet application set;
generating a member social media application set;
generating a member data analytics application set; and
generating a product management application set.

64. (canceled)

65. (canceled)

66. A method, comprising:
generating a deal Room application set responsive to one or more inputs indicative of a project type, a project category, a project deliverable, a project deliverable and project geographical scope, or a project deliverable and project funding source.

67. (canceled)

68. (canceled)

69. (canceled)

70. (canceled)

71. (canceled)

72. (canceled)

73. (canceled)

74. (canceled)
